(19) United States
(12) Patent Application Publication
(10) Pub. No.: US 2008/0080048 A1
(43) Pub. Date: Apr. 3, 2008

(54) Lens array unit and stereoscopic display apparatus including the same

(76) Inventors: Tatsuo Saishu, Tokyo (JP); Kazuki Taira, Tokyo (JP); Yoshiharu Momonoi, Tokyo (JP); Ryoichi Watanabe, Yokohama-shi (JP); Takashi Sasabayashi, Konosu-shi (JP); Masahiko Tomikawa, Funabashi-shi (JP); Masaki Obi, Ageo-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/902,453

(22) Filed: Sep. 21, 2007

(30) Foreign Application Priority Data
Sep. 29, 2006 (JP) 2006-269951

(51) Int. Cl. G02B 27/22; G02B 1/10

(52) U.S. Cl. 359/463; 359/620

(57) ABSTRACT

A lens array includes a glass substrate, a lens array layer, and a flat layer. The lens array layer and the flat layer are made of a resin material thinner than the glass substrate and have generally the same thickness. The lens array layer and the flat layer are adhered to the two sides of the glass substrate through adhesive layers to oppose each other through the glass substrate.

### CROSS-REFERENCE TO RELATED APPLICATIONS

This application is based upon and claims the benefit of priority from prior Japanese Patent Application No. 2006-269951, filed Sep. 29, 2006, the entire contents of which are incorporated herein by reference.

### BACKGROUND OF THE INVENTION

1. Field of the Invention

The present invention relates to a lens array unit and a stereoscopic display apparatus including the same.

2. Description of the Related Art

A stereoscopic image display apparatus capable of displaying a motion image, a 3D display, is available in a variety of schemes. Particularly, in recent years, a demand has arisen for a scheme of a flat panel type that does not require exclusive eyeglasses. Among stereoscopic motion image display apparatuses of this type, a scheme that utilizes the principle of holography is difficult to display a full color motion image. Another scheme in which a beam control element that controls a beam from the display panel and directs the beam toward the observer is set immediately in front of a pixel position-fixed display panel (display apparatus) such as a direct viewing type or projection type liquid crystal display apparatus, or a plasma display apparatus allows to display a full color motion image comparatively easily.

Generally, the beam control element is also called a parallax barrier, and controls the beam so that depending on the angle, different images can be seen even at one position on the beam control element. More specifically, when providing only right-and-left parallax (horizontal parallax), a slit array or a lenticular sheet (cylindrical lens array) is used. When including top-and-bottom parallax (vertical parallax) as well, a pinhole array or a lens array is used. Schemes that employ a parallax barrier are further classified into a binocular scheme, a multiview scheme, a super-multiview scheme (the super-multiview conditions for the multiview scheme), and integral photography (to be also referred to as IP hereinafter). These basic principles are substantially identical to those invented about 100 years ago and have been employed in stereoscopic photography.

Among these schemes, the characteristic feature of the IP scheme resides in that it provides high degrees of freedom for the viewpoint position and enables stereoscopic vision easily. The 1D IP scheme that includes only horizontal parallax and does not include vertical parallax can implement a high-resolution display apparatus comparatively easily, as described in SID04 Digest 1438 (2004). In contrast to this, with the binocular scheme or the multiview scheme, the range of the viewpoint position where stereoscopic vision is possible, i.e., the viewing area, is narrow, and the observer cannot see the image well. However, the binocular scheme or the multiview scheme has the simplest arrangement as the stereoscopic image display apparatus, and can generate a display image readily.

As the examples of the material of a lenticular sheet used in such a direct viewing type autostereoscopic display apparatus, a resin lenticular sheet, a glass lenticular sheet, a lenticular sheet in which a resin is adhered to a glass substrate (hybrid lenticular sheet), a lenticular sheet in which a resin forms a lens shape directly on a glass substrate (hybrid lenticular sheet), and the like are known. The resin is generally PMMA, PC, or the like. As the examples of the lens shape, a single convex structure, a double convex structure, a single convex two-layer structure, a structure with a single convex on the front side and a prism on the lower side, and the like are known. To prevent reflection of external light, generally, the convex surface of the lens array is directed to the liquid crystal panel. In this case, in order to achieve the lens effect, the lens array surface (a region that displays an image) is not adhered to the liquid crystal panel surface.

To obtain sufficient stereoscopic display characteristics, errors in lens pitch and in lens-pixel distance, variations due to the temperature, and planar unevenness must be suppressed. A resin lenticular sheet has a high coefficient of linear expansion. Hence, the lens pitch varies largely due to a temperature change, and the flatness and its stability are poor. A glass lenticular sheet has small lens pitch variations and high flatness but requires a high cost. A hybrid lenticular sheet has good initial flatness but warps according to a temperature change due to a difference in coefficient of linear expansion between glass and resin. This warp remains when the hybrid lenticular sheet is used for a long period of time.

In this manner, in the resin lenticular sheet, the lens pitch tends to vary, and the poor flatness and its stability are poor. The glass lenticular sheet, which has good flatness and does not cause lens pitch variations, easily requires a high cost. The hybrid lenticular sheet, which utilizes the advantages of both the glass lenticular sheet and resin lenticular sheet, tends to warp easily.

### BRIEF SUMMARY OF THE INVENTION

A lens array according to an aspect of the present invention comprises a glass substrate including a flat first surface and a flat second surface parallel to the flat first surface, a lens array layer adhered to the first surface of the glass substrate, and a flat layer adhered to the second surface of the glass substrate. The flat layer and the lens array layer oppose each other through the glass substrate. The lens array layer is made of a first resin material thinner than the glass substrate and the flat layer is made of a second resin material and has generally the same thickness as that of the lens array layer.

A stereoscopic display apparatus according to another aspect of the present invention comprises the lens array unit described above, and a display unit that is arranged to oppose a lens array layer side of the lens array unit and includes pixels arrayed in a matrix shape to display elemental image array.

### BRIEF DESCRIPTION OF THE SEVERAL VIEWS OF THE DRAWING

FIG. 1 is a perspective view of a lens array unit according to an embodiment;

FIG. 2 is a perspective view of another lens array unit according to an embodiment;

FIG. 3 is a horizontal sectional view of a lens array unit according to an embodiment;

FIG. 4 is a horizontal sectional view of another lens array unit according to an embodiment;

FIG. 5 is a horizontal sectional view of still another lens array unit according to an embodiment;

FIG. 6 is a horizontal sectional view of a stereoscopic display apparatus according to an embodiment;

FIG. 7 is a horizontal sectional view of another stereoscopic display apparatus according to an embodiment;

FIG. 8 is a horizontal sectional view of still another stereoscopic display apparatus according to an embodiment;

FIG. 9 is a horizontal sectional view of still another stereoscopic display apparatus according to an embodiment;

FIG. 10 is a perspective view schematically showing the overall arrangement of a stereoscopic image display apparatus according to an embodiment;

FIG. 11A is a front view of the display unit and the lens array unit in the stereoscopic display apparatus of FIG. 10;

FIG. 11B shows the beam reproduction ranges within the horizontal plane in the stereoscopic display apparatus of FIG. 10;

FIG. 11C shows a side view of the stereoscopic display apparatus of FIG. 10;

FIG. 12 is a perspective view schematically showing the arrangement of part of the stereoscopic image display apparatus according to the embodiment of FIG. 10;

FIG. 13 is a horizontal sectional view of a lens array unit according to a comparative example;

FIG. 14 is a horizontal sectional view of another lens array unit according to a comparative example;

FIG. 15 is a horizontal sectional view of still another lens array unit according to a comparative example; and

FIG. 16 is a horizontal sectional view of further another lens array unit according to a comparative example.

### DETAILED DESCRIPTION OF THE INVENTION

A stereoscopic display apparatus according to an embodiment of the present invention will be described in detail with reference to the accompanying drawing.

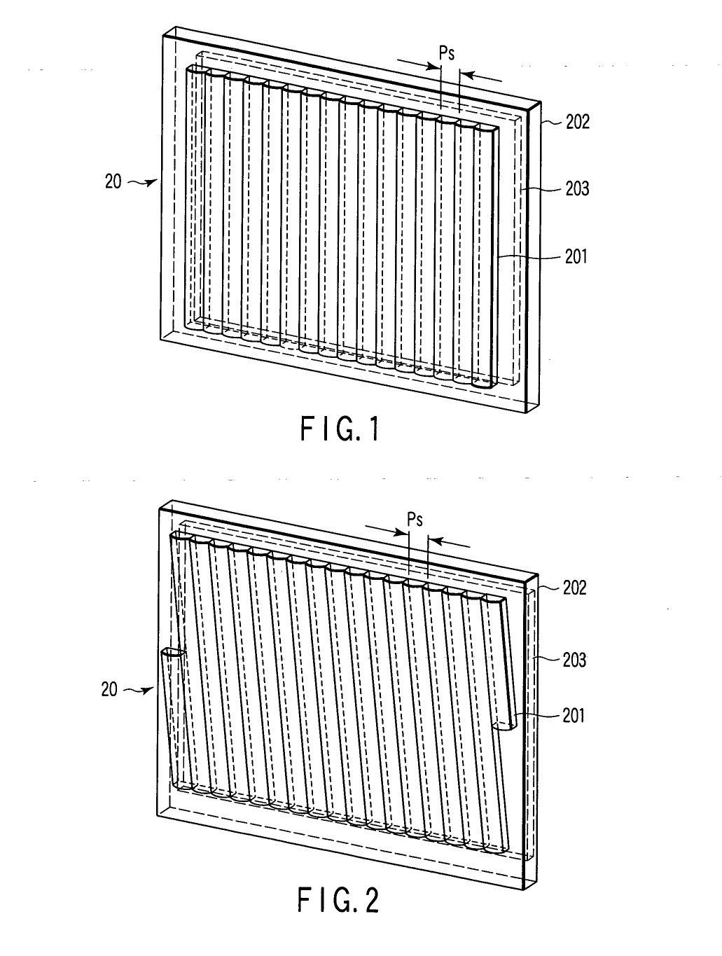

A lens array unit 20 shown in FIG. 1 includes an array of cylindrical lenses extending in the vertical direction. A lens array unit 20 shown in FIG. 2 includes an array of cylindrical lenses extending in the slanted direction. The lens array unit 20 comprises a uniform-thick glass substrate 202, a lens array layer 201, and a flat layer 203. A horizontal lens pitch Ps is a pitch in a direction that coincides with the direction of pixel columns of the elemental image display of a display unit (to be described later). The lens array layer 201 is made of a resin and can be manufactured at a low cost by press molding, injection molding, or extrusion molding. The resin has a high coefficient of linear expansion. To suppress variations in Ps caused by the temperature or change with time, the lens array layer 201 is adhered to the thick glass substrate 202. To prevent a warp caused by the difference in coefficient of linear expansion between glass and resin, the flat layer 203 having generally the same thickness as that of the lens array layer 201 is adhered to that side of the glass substrate 202 that is opposite to the lens array layer 201. The lens array layer 201 and flat layer 203 oppose each other through the glass substrate 202. The flat layer 203 is also made of a resin and can be manufactured at a low cost by drawing or the like. To realize stereoscopic display with beams in different directions with respect to the respective lens principal points of the lens array layer 201 as the references, considering the parallax, the flat layer 203 has an area slightly larger than that of the lens array layer 201. Alternatively, the flat layer 203 and lens array unit 20 may have generally the same area. The glass substrate 202 has an area slightly larger than that of the lens array layer 201. The extra portion of the glass substrate 202 may be used as an adhering portion to fix the lens array unit 20 to the display unit.

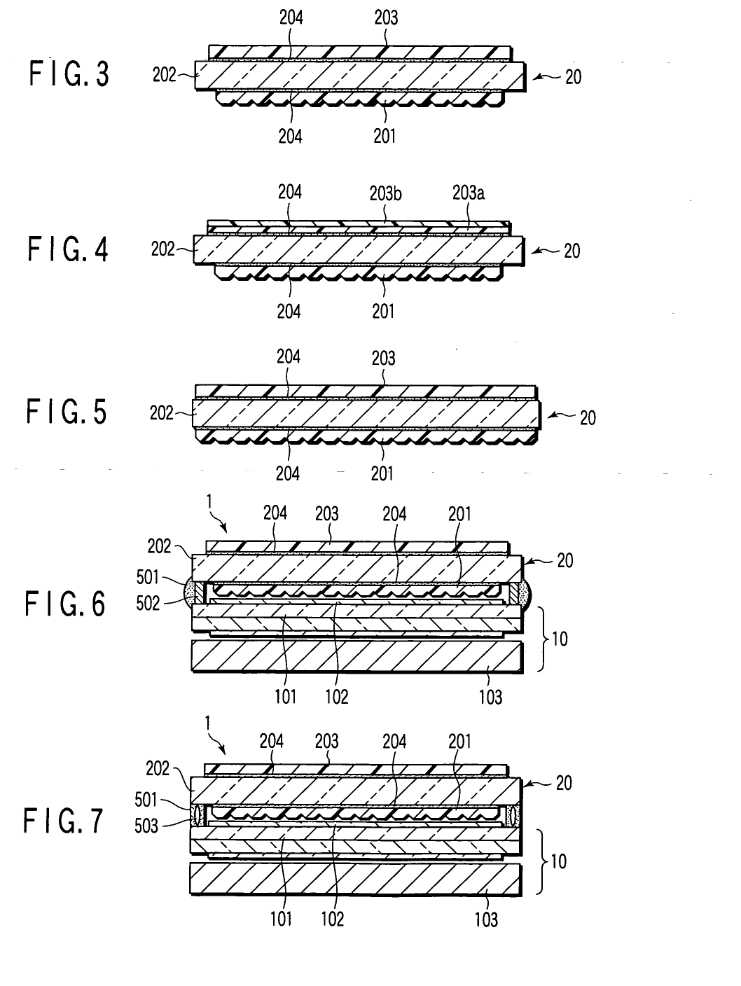

In FIGS. 3 to 5, which show lens array units 20 according to the embodiments of the present invention, the members denoted by the same reference numerals are identical members.

In the lens array unit 20 of FIG. 3, a lens array layer 201 and a flat layer 203 are adhered to the two sides of a glass substrate 202 through adhesive layers 204. The lens array layer 201 and the flat layer 203 are thinner than the glass substrate 202, and have generally the same thickness, so as to have generally the same coefficient of expansion. The thickness of the glass substrate 202 is desirably larger than that of the lens array layer 201 (the thickness of the flat layer 203). If the glass substrate 202 has a thickness larger than the sum of the thicknesses of the lens array layer 201 and the flat layer 203, although its stability against the warp improves, its weight increases. The adhesive layers are desirably made of the same material. This balances the adhesive strengths and flexibilities on the two sides of the glass substrate 202 and is thus effective for warp prevention. The lens array layer 201 and the flat layer 203 are desirably made of the same material. This balances the coefficients of linear expansion on the two sides of the glass substrate 202 and is thus effective for warp prevention. The thickness of the glass substrate is selected according to the necessity from, e.g., a general thickness of 0.7 mm, 1.1 mm, and a much larger thickness of several mm. The thickness of the lens array layer is selected according to the design from, e.g., about 0.2 mm to 0.5 mm with a lens top-valley depth of about 0.05 mm to 0.1 mm. The thickness of the flat layer is selected from, e.g., about 0.2 mm to 0.5 mm to be equal to that of the lens array layer.

In the lens array unit 20 of FIG. 4, a flat layer 203 has a multilayer structure and comprises resin material layers. The flat layer 203 comprises a resin layer 203a and a resin layer 203b. For warp prevention, desirably, at least one of the resin layers 203a and 203b may be made of the same material as that of a lens array layer 201. The upper resin layer 203b may be a layer with an anti-reflection function, e.g., an AR (Anti-Reflection) coat layer or an AG (Anti-Glare) layer. The inner resin layer 203a may be a polarizing film layer or the like. The polarizing film layer should be located between the display unit and the lens array layer 201. Otherwise, the polarizing film layer may be adversely affected by depolarization caused by the phase difference of the resin lens. If a polarizing film is to be included, it requires angle matching with the lens array.

The lens array unit 20 of FIG. 5 is generally the same as the lens array unit 20 of FIG. 3, but its glass substrate 202, lens array layer 201, and flat layer 203 have generally the same area. In this lens array unit 20, the lens array layer is formed to cover an area larger than the display range of the elemental image display. All the lenses are not necessary used for display, and those on the peripheral portion may be used as a fixing portion with respect to the display unit.

Such a lens array unit 20 has generally a symmetric structure in the direction of thickness, if details such as steps on the lens surface are ignored. This prevents a warp and suppresses variations in lens pitch to improve the durability and reliability. Also, as the lens array unit 20 has a hybrid structure, it can be manufactured at a comparatively low cost.

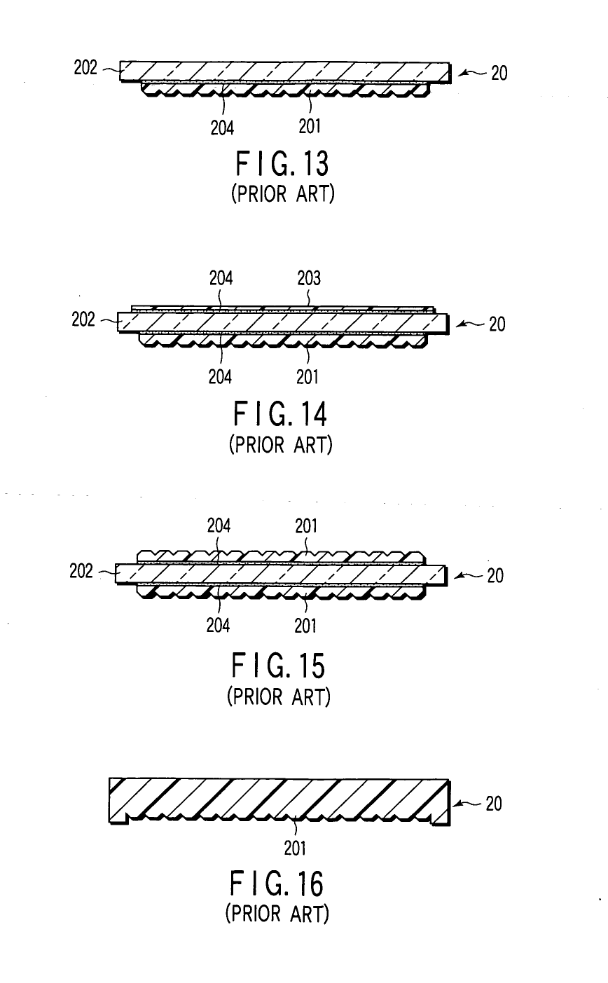

In a lens array unit 20 shown in FIG. 13 as a comparative example that tends to warp easily, a lens array layer 201 is adhered to only one side of a glass substrate 202. This lens array unit 20 tends to warp according to the temperature due to the difference in coefficient of linear expansion between glass and a resin. The warp may remain when the lens array unit 20 is used for a long period of time. If the glass substrate 202 is very thick, the lens array unit 20 will not warp. In this case, however, the entire weight increases, which is not preferable.

In a lens array unit 20 shown in FIG. 14 as another comparative example that tends to warp easily, although a lens array layer 201 and a flat layer 203 are respectively provided to the two sides of a glass substrate 202, the flat layer 203 is thinner than the lens array layer 201. This lens array unit 20 tends to warp easily since the lens array layer 201 and flat layer 203 do not balance well.

In a lens array unit 20 shown in FIG. 15 as still another comparative example, lens array layers 201 are adhered to the two sides of a glass substrate 202. This lens array unit 20 has a symmetric structure and accordingly does not warp easily. However, alignment of the lens array layer 201 on the two sides during the manufacture is difficult. In terms of stereoscopic display characteristics, a sufficient viewing area cannot be ensured due to the limitations of parallax between two lens layers.

A lens array unit 20 shown in FIG. 16 as further another comparative example is entirely made of a resin material. Thus, the lens pitch varies largely according to the temperature, and the flatness and its stability are poor, leading to an unstable stereoscopic display performance.

As shown in FIGS. 6 to 8, each stereoscopic display apparatus 1 includes the lens array unit 20 and the display unit 10 having pixels arrayed in a matrix shape to display elemental image array. The display unit 10 is arranged to oppose the lens array layer 201 side of the lens array unit 20. The display unit 10 comprises a glass substrate 101, a polarizing film 102, and the like, and includes a backlight unit 103 as well for a transmissive liquid crystal display panel or the like.

In the lens array unit 20, the lens array layer 201 side is arranged to face the display unit 10 side. Even when a flat layer 203 side is arranged to face the display unit 10 side, stereoscopic display is possible. When using a thick glass substrate 202 for achieving the durability and reliability, however, the lens focal length increases to impose limitations on the lens design. When further providing a face glass to the outer side to prevent external light reflection of the convex lens surface, the number of components and the weight increase.

In the stereoscopic display apparatus 1 of FIG. 6, the lens array unit 20 and the display unit 10 are fixed only at the peripheral portion, so that a lens array layer 201 is not in contact with the surface of the display unit 10. At the peripheral portion, a glass substrate 202 of the lens array unit 20 is fixed to the glass substrate 101 of the display unit 10 through an adhesive 501 through a spacer 502 to maintain the distance between the lens array unit 20 and the display unit 10. The spacer 502 may include a metal plate, a resin plate, a glass plate, or the like. The spacer 502 need not be a plate but may be a rod or a small piece. The adhesive 501 may include a thermoset resin, an ultraviolet curing resin, or the like.

In the stereoscopic display apparatus 1 of FIG. 7, at the peripheral portion, a glass substrate 202 of the lens array unit 20 is fixed to the glass substrate 101 of the display unit 10 through an adhesive 501 that is mixed with a spacer 503 to maintain the distance between the lens array unit 20 and the display unit 10. In this case as well, the lens array unit 20 and the display unit 10 are fixed only at the peripheral portion, so that a lens array layer 201 is not in contact with the surface of the display unit 10. The spacer 503 may include spacer beads, cut fibers, milled fibers, or the like. The adhesive 501 may include a thermoset resin, an ultraviolet curing resin, or the like.

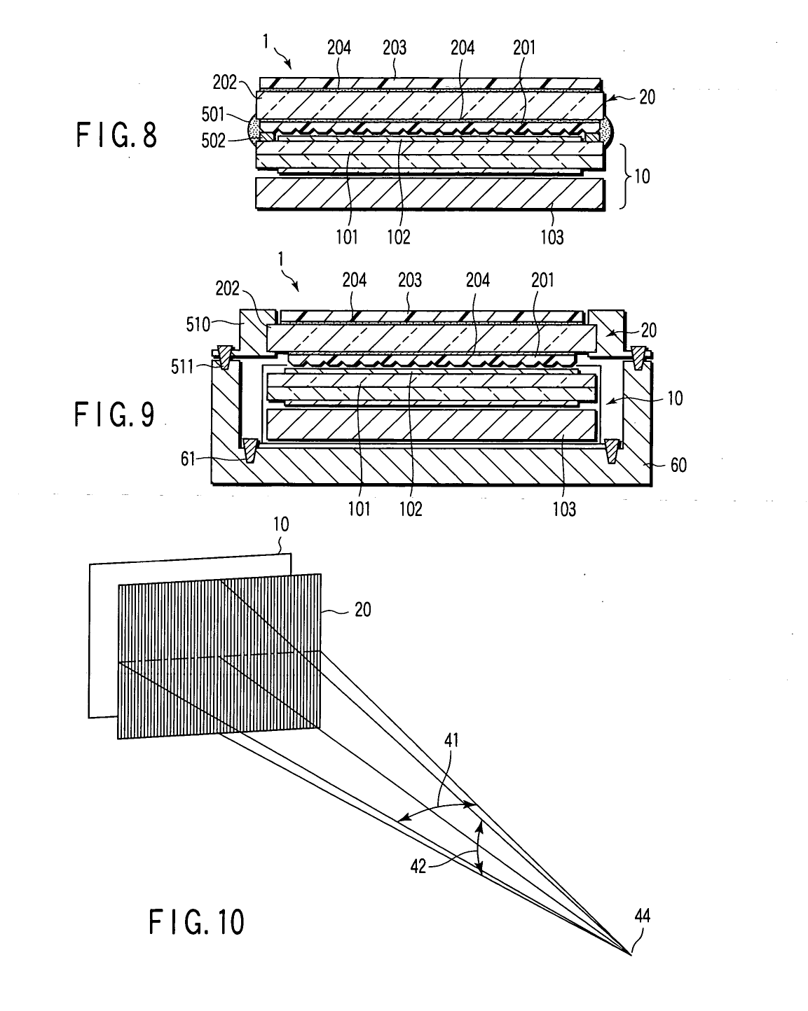

In the stereoscopic display apparatus 1 of FIG. 8, a lens array layer 201 of the lens array unit 20 is fixed to the glass substrate 101 of the display unit 10 through a spacer 502 by an adhesive 501. In this example, the lens array unit 20 and the display unit 10 do not adhere to each other in the image display area but fix to each other only at the peripheral portion.

As shown in FIGS. 6 to 8, by directly fixing the lens array unit 20 to the display unit 10, the distance between them is stably fixed, and the stability of the stereoscopic display performance is ensured.

In the stereoscopic display apparatus 1 of FIG. 9, the lens array unit 20 and the display unit 10 are fixed not directly but through a housing or the like. A frame 510 is attached to the lens array unit 20. The frame 510 is fixed to the housing 60 by screws 511 or the like. A bezel and a housing of the display unit 10 are fixed to a housing 60 with screws 61 or the like. According to this stereoscopic display apparatus 1, the position of the frame 510 is adjustable, so that the position of the lens array unit 20 can be finely adjusted. Since the frame 510 is removable, the lens array unit 20 can be detached, so the display unit 10 alone can be used as a display apparatus.

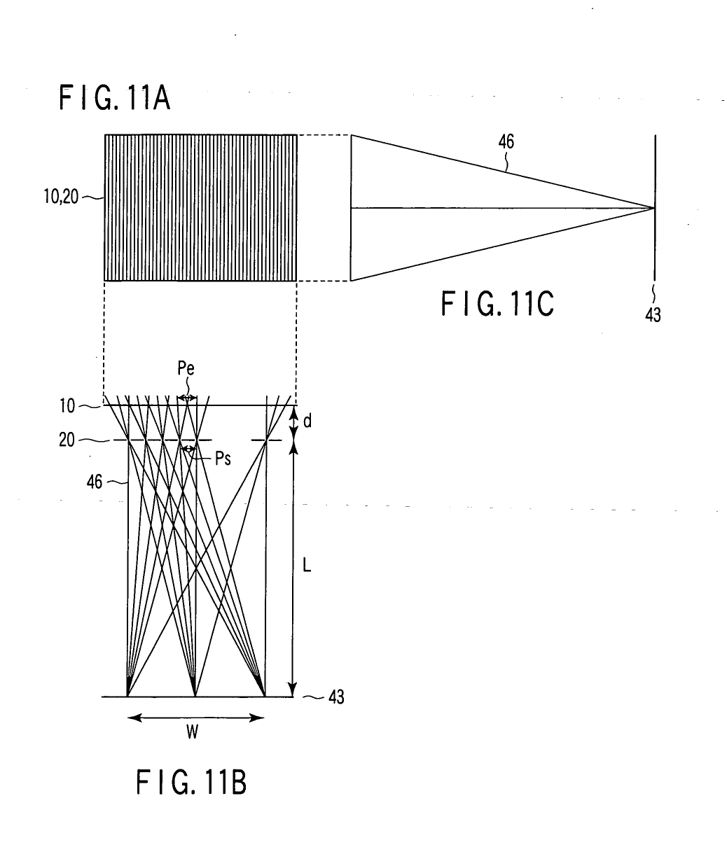

Stereoscopic display according to the 1D IP scheme or the multiview scheme will be described with reference to FIGS. 10 to 12.

A display unit 10 including an elemental image display is a high-resolution liquid crystal panel module in which pixels are arrayed in a matrix shape. The elemental image display may include a plasma display panel, an organic EL display panel, a field emission type display panel, or the like, and may be of any type as far as its pixels are arrayed in a matrix shape. An observer at an assumed position 44 observes a stereoscopic image near the front surface and the rear surface of the lens array unit 20 within the ranges of a horizontal visual angle 41 and a vertical visual angle 42.

Referring to FIGS. 11A to 11C, when a viewing area L between the lens array unit 20 and a viewing plane 43, a beam control element horizontal pitch Ps, and a gap d between the beam control element and the pixel plane are specified, an elemental image horizontal pitch Pe is determined by the intervals at which the aperture centers (or lens principal points) are projected onto the elemental image display plane (pixel plane) from the viewpoint on the viewing plane 43. Reference numeral 46 denotes a line that connects the viewpoint position and the respective aperture centers (lens principal points). A viewing area width W is determined by the condition that the elemental images do not overlap on the pixel plane. For the 1D IP scheme under the condition of having sets of parallel beams, the average value of the horizontal pitches of the elemental images is slightly larger than an integer multiple of the sub-pixel horizontal pitch, and the horizontal pitch of the beam control element is equal to an integer multiple of the sub-pixel horizontal pitch. For the multiview scheme, the horizontal pitch of the elemental images is equal to an integer multiple of the sub-pixel horizontal pitch, and the horizontal pitch of the beam control element is slightly smaller than an integer multiple of the sub-pixel horizontal pitch.

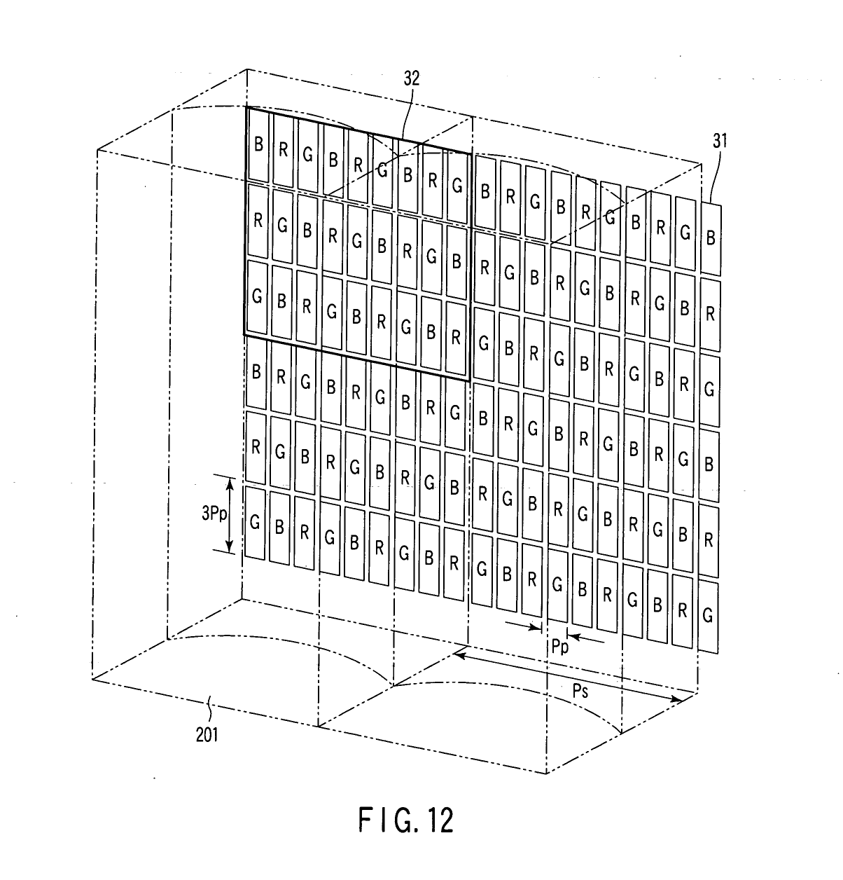

Referring to FIG. 12, a cylindrical lens array (lenticular sheet) 201 is arranged on the front surface of a flat panel type elemental image display such as a liquid crystal panel. As shown in FIG. 12, in the elemental image display, sub-pixels 31 having an aspect ratio of 3:1 are arranged linearly in the lateral direction and the longitudinal direction in a matrix shape. The sub-pixels 31 are arrayed so that red (R), green (G), and blue (B) alternate in the row direction and the column direction. This color arrangement is generally called a mosaic arrangement. Nine columns×3 rows of sub-pixels 31 constitute one effective pixel 32 (indicated by a solid frame) in stereoscopic display. In this display structure, in stereoscopic display, one effective pixel 32 comprises 27 sub-pixels. Assuming that one parallax requires three color components, stereoscopic image display that provides nine parallaxes in the horizontal direction is possible. The effective pixel refers to the minimal unit of sub-pixel groups that determines the resolution in stereoscopic display, and the elemental image refers to the set of parallax component images corresponding to one lens. Hence, for a stereoscopic display apparatus that uses a cylindrical lens, one elemental image includes a large number of effective pixels lining up in the longitudinal direction.

The lens array unit of each embodiment is balanced on the two sides of the glass substrate because of the symmetric structure. This suppresses the warp of the lens array layer. In the stereoscopic display apparatus that uses such a lens array unit, the durability and reliability are improved.

The present invention is not limited to the above embodiments. When practicing the invention, the present invention can be implemented by modifying the constituent elements without departing from the spirit and scope of the invention.

Appropriate combinations of the constituent elements disclosed in the above embodiments can constitute various types of inventions. For example, several components may be omitted from all the components illustrated in the embodiments. Furthermore, components according to different embodiments may be combined appropriately.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A lens array comprising:
a glass substrate including a flat first surface and a flat second surface parallel to the flat first surface;
a lens array layer that is adhered to the first surface of the glass substrate and is made of a first resin material thinner than the glass substrate; and
a flat layer that is adhered to the second surface of the glass substrate to oppose the lens array layer, is made of a second resin material, and has generally the same thickness as that of the lens array layer.

2. The lens array according to claim 1, wherein the flat layer has generally the same coefficient of expansion as that of the lens array layer.

3. The lens array according to claim 1, wherein the lens array comprises a cylindrical lens array.

4. The lens array according to claim 2, wherein the first resin material and the second resin material are the same material.

5. The lens array according to claim 1, wherein the flat layer comprises resin material layers, and at least one of the resin material layers is made of the same material as the first resin material.

6. The lens array according to claim 1, wherein the flat layer comprises resin material layers, and one of the resin material layers comprises a polarizing film layer.

7. The lens array according to claim 1, wherein the flat layer has an area larger than that of the lens array layer.

8. The lens array according to claim 1, wherein adhesive layers on the first and second surfaces of the glass substrate are made of the same adhesive material.

9. The lens array according to claim 1, further comprising an anti-reflection layer formed on a surface of the flat layer that is on a side different from a glass substrate side.

10. A stereoscopic display apparatus comprising a lens array unit according to claim 1, and a display unit that is arranged to oppose a lens array layer side of the lens array unit and includes pixels arrayed in a matrix shape to display elemental image array.

11. The apparatus according to claim 10, wherein the lens array unit and the display unit are not adhered to each other on a surface of the lens array layer within an elemental image display range but are fixed to each other only at a peripheral portion.
